(19) United States
(12) Patent Application Publication
(10) Pub. No.: US 2025/0021944 A1
(43) Pub. Date: Jan. 16, 2025

(54) SYSTEM AND METHOD CONFIGURED TO TRACE CHANGES IN APPLIED COMPUTER TECHNOLOGY

(71) Applicant: Morgan Stanley Services Group Inc., New York, NY (US)

(72) Inventors: Harikrishna Kota, Karnataka (IN); Yatinder Kumar, Hasbrouck Heights, NJ (US); Sharad Pisal, Maharashtra (IN)

(73) Assignee: Morgan Stanley Services Group Inc., New York, NY (US)

(21) Appl. No.: 18/351,915

(22) Filed: Jul. 13, 2023

(51) Int. Cl. G06Q 10/20

(52) U.S. Cl. CPC G06Q 10/20; G06F 8/71

(57) ABSTRACT

A change tracer system and method are configured to trace changes in applied computer technology in a computing system. The change tracer system comprises a harvest system receiving current change data, change storage storing the current change data and historic change data, a comparator system comparing the current change data with the historic change data and determining the change from the comparison, and an output system outputting a report indicating the change. The method implements the system.

### FIELD OF THE DISCLOSURE

The present disclosure relates generally to monitoring computer technology, and, more particularly, to a system and method configured to trace changes in applied computer technology.

### BACKGROUND OF THE DISCLOSURE

Computer technology is pervasive throughout computer-based systems and networks. However, such computer technology often cannot be static, but must be maintained or updated to meet the needs of their environments. For example, cybersecurity software applications need to be regularly updated with information about recent malware and viruses. Also, applied computer technology can often be required to implement changes to meet financial regulations such as in stock trading applications. The maintenance and updating of such applied computer technology presents a significant undertaking to ensure that changes in applied computer technology do not adversely affect the overall systems and networks.

Tracking and tracing changes in applied computer technology has traditionally been performed manually to record such changes. However, the number and degree of such changes can present a nearly impossible task for manual change tracing, as well as being prone to human error. In addition, a change in one application can impact some applications, while not impacting other applications. It can be overwhelming to perform manual change tracing to track the dependencies of different applications, and to correlate changes to applications in which the number of correlations can number in the hundreds or even thousands.

### SUMMARY OF THE DISCLOSURE

According to an embodiment consistent with the present disclosure, an automated computer-based system and method trace changes in applied computer technology.

In an embodiment, a change tracer system is configured to trace a change in an applied computer technology in a computing system. The change tracer system comprises a harvest system, a change storage, a comparator system, and an output system. The harvest system has a first processor including first code stored therein configured to receive, from the computing system, current change data representing the change. The change storage is configured to store the received current change, and to store historic change data associated with the applied computer technology. The comparator system has a second processor including second code stored therein configured to compare the current change data with the historic change data, and to determine the change from the comparison of the current change data with the historic change data. The output system has a third processor including third code stored therein configured to output a report indicating the change in the applied computer technology.

The applied computer technology can be selected from the group consisting of: hardware, software, and middleware. The change tracer system can further comprise a display having a user interface configured to display the outputted report. The report can be in an Email format. The change tracer system can further comprise a remediation system having a fourth processor including fourth code stored therein configured to remediate the change. The change storage can be configured to store the current change data and the historic change data as change data objects, and the comparator system can be configured to compare the change data objects corresponding to the current change data and the historic change data, and to determine the change from the comparison of change data objects. The change tracer system can further comprise an instrument system having a fourth processor with fourth code stored therein configured to receive application asset information associated with the applied computer technology from an external database, wherein the change storage can be configured to store the received application asset information as asset data objects, and wherein the comparator system can be configured to compare the asset data objects corresponding to the applied computer technology, and to determine the change from the comparison of change data objects and from the comparison of the asset data objects.

In another embodiment, a system is configured to trace a change in an applied computer technology. The system comprises a harvest subsystem, a change storage, a comparator subsystem, an output subsystem, and a remediation subsystem. The harvest subsystem has a first processor including first code stored therein configured to receive current change data representing the change in the applied computer technology. The change storage is configured to store the received current change data, and to store historic change data associated with the applied computer technology. The comparator subsystem has a second processor including second code stored therein configured to compare the current change data with the historic change data, and to determine the change from the comparison of the current change data with the historic change data. The output subsystem has a third processor including third code stored therein configured to output a report indicating the change in the applied computer technology. The remediation subsystem has a fourth processor including fourth code stored therein configured to determine whether the change is proper, and in the case that the change is improper, to remediate the change.

The applied computer technology can be selected from the group consisting of: hardware, software, and middleware. The system can further comprise a display having a user interface configured to display the outputted report. The report can be in an Email format. The change storage can be configured to store the current change data and the historic change data as change data objects, and the comparator subsystem can be configured to compare the change data objects corresponding to the current change data and the historic change data, and to determine the change from the comparison of change data objects. The system can further comprise an instrument subsystem having a fifth processor with fifth code stored therein configured to receive application asset information associated with the applied computer technology from an external database, wherein the change storage is configured to store the received application asset information as asset data objects, and wherein the comparator subsystem is configured to compare the asset data objects corresponding to the applied computer technology, and to determine the change from the comparison of change data objects and from the comparison of the asset data objects.

In a further embodiment, a method comprises intercepting a change regarding an applied computer technology, obtaining change data representing the change, converting the change data into change data objects, comparing the change data objects over time, generating a report of the change from the comparison of change data objects, and outputting the report.

The applied computer technology can be selected from the group consisting of: hardware, software, and middleware. Outputting the report can include displaying the report in a user interface of a display. Generating the report can include generating the report in an Email format, and outputting the report can include Emailing the report. The method can further comprise determining whether the change is improper, and in the case that the change is improper, remediating the change. The method can also further comprise storing the obtained change data as current change data objects and historic change data objects. The comparing of the change data objects over time can further comprise comparing the current change data objects with the historic change data objects, and determining the change from the comparison of the current change data objects and the historic change data objects.

Any combinations of the various embodiments and implementations disclosed herein can be used in a further embodiment, consistent with the disclosure. These and other aspects and features can be appreciated from the following description of certain embodiments presented herein in accordance with the disclosure and the accompanying drawings and claims.

### BRIEF DESCRIPTION OF THE DRAWINGS

FIG. 1 is a schematic of a system configured to perform change tracing, according to an embodiment.

FIG. 2 is a schematic of a computing device used in the system of FIG. 1.

FIG. 3 is a schematic of a change storage used in the system of FIG. 1.

FIG. 4 is a schematic of the storage of objects by the change storage of FIG. 3.

FIG. 5 is a flowchart of operation of the system of FIG. 1.

FIG. 6 is a flowchart of remediation of a change.

It is noted that the drawings are illustrative and are not necessarily to scale.

### DETAILED DESCRIPTION OF CERTAIN EMBODIMENTS OF THE DISCLOSURE

Example embodiments consistent with the teachings included in the present disclosure are directed to a system and method configured to trace changes in applied computer technology.

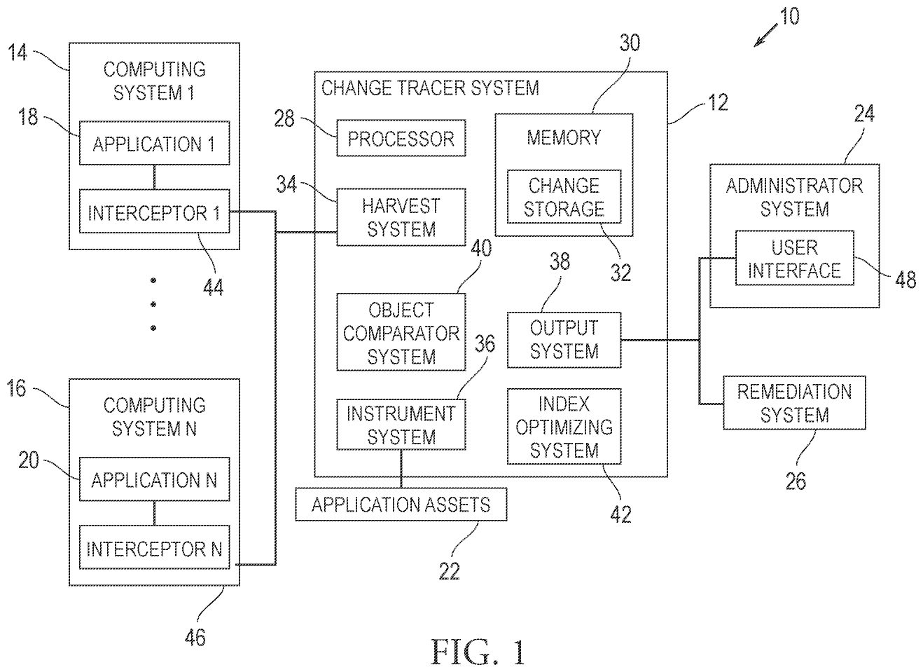

As shown in FIG. 1, the system 10 includes a change tracer system 12 operatively connected to at least one computing system 14, 16 having at least one application 18, 20 of computer technology, respectively, which can experience a change traced by the change tracer system 12. Each application 18, 20 can be hardware, infrastructure, middleware, or software which implements any known computer technology. The change tracer system 12 is also operatively connected to application assets 22, an administrator system 24, and a remediation system 26, as described in greater detail below. The change tracer system 12 includes a processor 28, a memory 30 including a change storage 32, a harvest system 34, an instrument system 36, an output system 38, an object comparator system 40, and an index optimizing system 42. The harvest system 34 is operatively connected to a respective interceptor 44, 46 of each computing system 14, 16, respectively, as described in greater detail below.

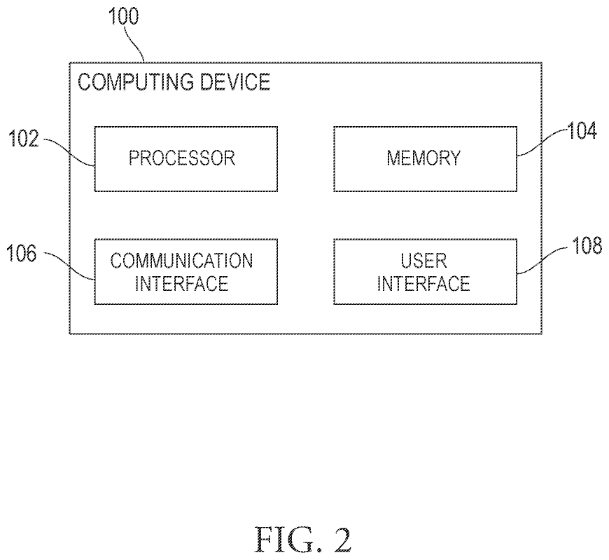

FIG. 2 illustrates a schematic of a computing device 100 including a processor 102 having code therein, a memory 104, and a communication interface 106. Optionally, the computing device 100 can include a user interface 108. The processor 102, the memory 104, the communication interface 106, and the user interface 108 can be operatively connected to each other via any known connections, such as a system bus, a network, etc. Any component or combination of components of the system 10 in FIG. 1 can be implemented by a respective computing device 100. For example, each of the change tracer system 12, the computing systems 14, 16, the administrator system 24, the remediation system 26, the processor 28, the memory 30, the harvest system 34, the instrument system 36, the output system 38, the object comparator system 40, and the index optimizing system 42 shown in FIG. 1 can be implemented by a respective computing device 100 shown in FIG. 2 and described below.

It is to be understood that the computing device 100 can include different components. Alternatively, the computing device 100 can include additional components. In another alternative embodiment, some or all of the functions of a given component can instead be carried out by one or more different components. The computing device 100 can be implemented by a virtual computing device. Alternatively, the computing device 100 can be implemented by one or more computing resources in a cloud computing environment. Additionally, the computing device 100 can be implemented by a plurality of any known computing devices.

The processor 102 can include one or more general-purpose processors. Alternatively, the processor 102 can include one or more special-purpose processors. The processor 102 can be integrated in whole or in part with the memory 104, the communication interface 106, and the user interface 108. In another alternative embodiment, the processor 102 can be implemented by any known hardware-based processing device such as a controller, an integrated circuit, a microchip, a central processing unit (CPU), a microprocessor, a system on a chip (SoC), a field-programmable gate array (FPGA), or an application-specific integrated circuit (ASIC). In addition, the processor 102 can include a plurality of processing elements configured to perform parallel processing. In a further alternative embodiment, the processor 102 can include a plurality of nodes or artificial neurons configured as an artificial neural network. The processor 102 can be configured to implement any known artificial neural network, including a convolutional neural network (CNN).

The memory 104 can be implemented as a non-transitory computer-readable storage medium such as a hard drive, a solid-state drive, an erasable programmable read-only memory (EPROM), a universal serial bus (USB) storage device, a floppy disk, a compact disc read-only memory (CD-ROM) disk, a digital versatile disc (DVD), cloud-based storage, or any known non-volatile storage.

The code of the processor 102 can be stored in a memory internal to the processor 102. The code can be instructions implemented in hardware. Alternatively, the code can be instructions implemented in software. The instructions can be machine-language instructions executable by the processor 102 to cause the computing device 100 to perform the functions of the computing device 100 described herein. Alternatively, the instructions can include script instructions executable by a script interpreter configured to cause the processor 102 and computing device 100 to execute the instructions specified in the script instructions. In another alternative embodiment, the instructions are executable by the processor 102 to cause the computing device 100 to execute an artificial neural network.

The memory 104 can store data in any known format, such as databases, data structures, data lakes, or network parameters of a neural network. The data can be stored in a table, a flat file, data in a filesystem, a heap file, a B+ tree, a hash table, or a hash bucket. The memory 104 can be implemented by any known memory, including random access memory (RAM), cache memory, register memory, or any other known memory device configured to store instructions or data for rapid access by the processor 102, including storage of instructions during execution.

The communication interface 106 can be any known device configured to perform the communication interface functions of the computing device 100 described herein. The communication interface 106 can implement wired communication between the computing device 100 and another entity. Alternatively, the communication interface 106 can implement wireless communication between the computing device 100 and another entity. The communication interface 106 can be implemented by an Ethernet, Wi-Fi, Bluetooth, or USB interface. The communication interface 106 can transmit and receive data over the network 14 and to other devices using any known communication link or communication protocol.

The user interface 108 can be any known device configured to perform user input and output functions. The user interface 108 can be configured to receive an input from a user. Alternatively, the user interface 108 can be configured to output information to the user. The user interface 108 can be a computer monitor, a television, a loudspeaker, a computer speaker, or any other known device operatively connected to the computing device 100 and configured to output information to the user. A user input can be received through the user interface 108 implementing a keyboard, a mouse, or any other known device operatively connected to the computing device 100 to input information from the user. Alternatively, the user interface 108 can be implemented by any known touchscreen. The computing device 100 can include a server, a personal computer, a laptop, a smartphone, or a tablet.

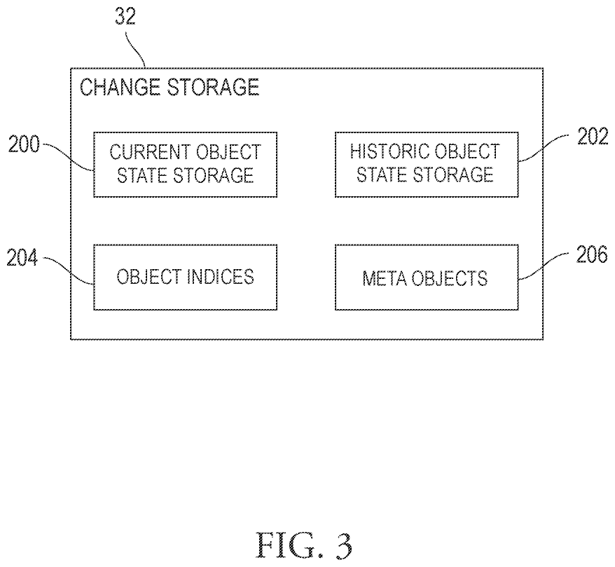

Referring back to FIG. 1, each interceptor 44, 46 is configured to monitor a respective application 18, 20 for a change. Each interceptor 44, 46 can be a subsystem of the computing system 14, 16, respectively. Alternatively, each interceptor 44, 46 can be monitoring code executed by the respective computing system 14, 16. In one embodiment, the monitoring code of each interceptor 44, 46 can be separate from the application 18, 20, respectively, which is monitored by the respective interceptor 44, 46. In an alternative embodiment, the monitoring code of each interceptor 44, 46 can be incorporated into the software code a respective application 18, 20. Each interceptor 44, 46 evaluates a set of rules to determine whether the associated application 18, 20 has changed. The change can span multiple application assets 22. Monitoring a change can involve identifying all application assets across multiple software stacks in a computing system and supporting middleware. If the application 18, 20 has changed, the respective interceptor 18, 20 generates and records change data specifying the determined change in the application 18, 20. The interceptors 18, 20 can record the change data in a memory of the associated computing system 14, 16, respectively. The interceptors 18, 20 transmit the change data to the harvest system 34. The harvest system 34 can store the change data in the change storage 32. The harvest system 34 can use file structure semantics to store such change data. The file structures semantics and the changed data are stored in an object store. The object store can be stored in the memory 30. Alternatively, the object store can be stored in the change storage 32; for example, the objects can be stored in the current object state storage 200 or the historic object stage storage 202 shown in FIG. 3. In the object store, the change data of each applications asset type is represented into an object and maintained in a compressed object store with a checksum to uniquely identifying an object. The content of each collected object varies based on the asset type and the change per application/technology system. This object in turn gets added to the indexing object of an application system; for example, the object is indexed by the object indices 204 in the change storage 32.

The instrument system 36 is configured to access and retrieve information regarding application assets 22 associated with each application 18, 20 being monitored. The application assets 22 can include software libraries, schedulers, middleware, infrastructure components, third party components, and other known asset types associated with an application. The application assets 22 can be stored in an external database. For example, the external database can include a technology asset inventory (TAI) which is a repository of technology assets owned by or associated with an application 18, 20. Alternatively, the application assets 22 can be stored in at least one of the computing systems 14, 16 associated with the respective applications 18, 20. The instrument system 36 retrieves such information about the application assets, and provides such retrieved information to the harvest system 34. The harvest system 34 associates the retrieved information with the change data of a given application 18, 20.

The output system 38 is configured to receive the change data and the received information associated with the application assets of an application 18, 20. The output system 38 then outputs the change data and application asset information. In one embodiment, the output system 38 outputs the change data and application asset information to the administrator system 24. The administrator system 23 is configured to allow a system administrator to review the change data and associated application asset information. In one embodiment, the administrator system includes a user interface 48. The user interface 48 can be an output device such as a display. In addition, the user interface 48 can include a graphic user interface (GUI) configured to interactively display the change data and associated application asset information to a user, such as the system administrator. The displayed change data and associated application asset information can be in the form of a change tracer report specifying a given application 18, 20 and the changes to the given application. Alternatively, the change tracer report can be transmitted to a user, such as the system administrator, in the form of an Email. In another alternative embodiment, the user interface 48 can be a printer to generate and print the change tracer report for a user, such as the system administrator. In addition, the administrator system 24 can include surveillance and reporting utility applications to allow a user to view changes in applications over time. The changes can be highlighted for ease of review by the user.

In another embodiment, the output system 38 outputs the change data and application asset information to the remediation system 26. The remediation system 26 can evaluate the change in a given application 18, 20 using a predetermined set of rules, for example, to determine whether a change is proper or improper. For example, an improper change can cause a problem with the computing system 14, 16 associated with the changed application 18, 20. In one embodiment, an improper change in an application can violate regulation requirements such as in a financial environment. In another embodiment, an improper change can cause a conflict between the given application and another application in a respective computing system 14, 16. Alternatively, an improper change can cause a conflict between the given application in a computing system 14, 16 and an application external to the computing system 14, 16. In a further embodiment, an improper change can cause a system outage of at least one computing system 14, 16. If a change is improper, the remediation system 26 is configured to reverse the change. Accordingly, the remediation system 26 can reduce or eliminate problems caused by a change in an application. For example, the remediation system 26 can reduce outage effects and the duration of an outage of a given computing system 14, 16 by decomposing the change and improve recovery from the change.

Referring to FIG. 3, the change store 32 can include a current object state storage 200, a historic object state storage 202, a set of object indices 204, and a set of meta objects 206. The current object state storage 200 includes current change data received from the harvest system 34, and current application asset information from the instrument system 36. The change tracer system 12 uses object storage and object processing to efficiently handle large volumes of data involving the applications 18, 20 and their dependencies. The change data and the application asset information, obtained by the harvest system 34 and the instrument system 36, respectively, is divided into separate, self-contained units or objects stored in a flat environment in the change storage 32. For example, the processor 28 of the change tracer system 12 converts the change data and the application asset information into objects. For example, the objects can be in a text format, such as by using JSON serialization. The change data, meta and index information of an asset information are represented in the object store in a compressed JSON serialized format.

Alternatively, each of the harvest system 34 and the instrument system 36 converts the change data and the application asset information, respectively, into objects to be stored in the change storage 32. In another alternative embodiment, the memory 30 converts the change data and the application asset information, respectively, into objects to be stored in the change storage 32. All objects are stored at a common storage level in the change storage 32. In addition, the change storage 32 does not store all data together in a single file in the memory 30 of the change tracer system 12. The current object state storage 200 stores the most recent change data from the interceptors 44, 46. The historic object state storage 202 stores previously obtained change data from the interceptors 44, 46.

Objects can also contain metadata, as the meta objects 206, which is information about objects and which facilitates the processing and usability of the objects corresponding to the change data. In one embodiment, a user such as a system administrator can set a value for fixed-key metadata associated with at least one object. Alternatively, the user can create both a key and a value for custom-generated metadata associated with at least one object. The metadata facilitates the quick and efficient gaining of value from the change data. Each object obtained from the change data is uniquely identified by a checksum number, which promotes the efficient handling of large amounts of data and information, and prevents duplication of objects from the change data. Such large amounts of data and information can be used in artificial intelligence, machine learning, and big data analytics.

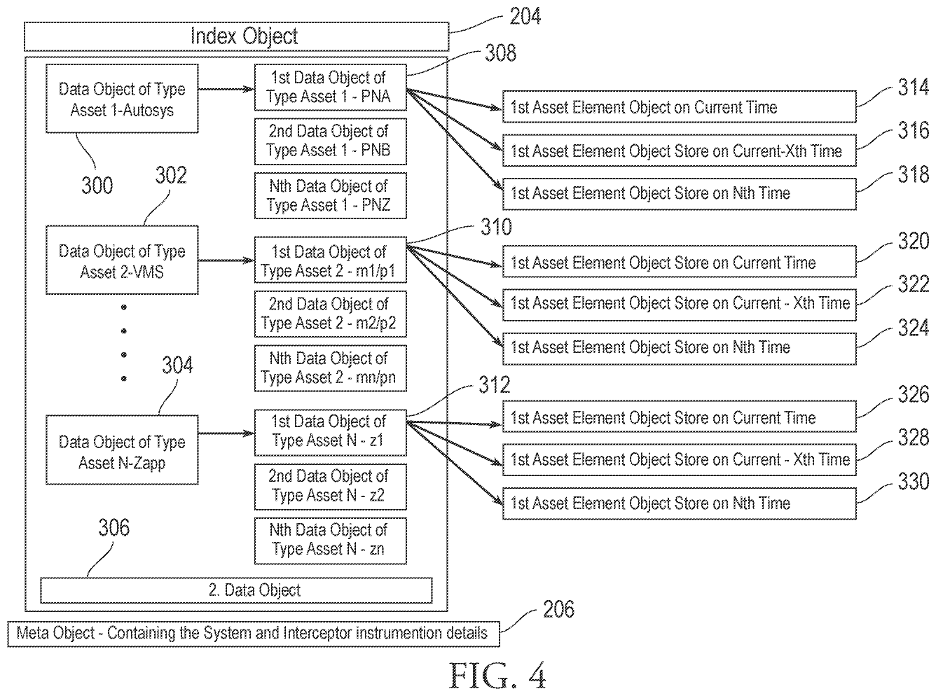

The change storage 32 in FIG. 3 is shown in greater detail in FIG. 4. As shown in FIG. 4, an index object 204 and a meta object 206 are associated with data objects 300, 302, 304, 306. The data object 300 can be associated with data of a first asset type, such as for Autosys. The data object 302 can be associated with data of a second asset type, such as for VMS. The data object 304 can be associated with data of an Nth asset type, such as for Zapp. Each data object 300, 302, 304 can be further associated with at least one other data object, such as data object 308, 310, 312, respectively. For example, the data object 300 can be associated with a first data object 308 of a first asset type labelled PNA, as well as a second data object of a first asset type labelled PNB, and an Nth data object of a first asset type labelled PNZ in FIG. 4. Similarly, the data object 302 can be associated with a first data object 310 of a second asset type labelled m1/p1, as well as a second data object of a second asset type labelled m2/p2, and an Nth data object of a second asset type labelled mn/pn in FIG. 4. In addition, the data object 304 can be associated with a first data object 312 of an Nth asset type labelled z1, as well as a second data object of an Nth asset type labelled z2, and an Nth data object of an Nth asset type labelled zn in FIG. 4.

The data objects 308, 310, 312 in FIG. 4 are further associated with elements in the object state storages 200, 202 in FIG. 3. For example, for the data object 308, the element 314 is a first asset element in the current object state storage 200 at a current time, while the element 316 is a first asset element in the historic object state storage 202 at a (current−Xth) time, and the element 318 is a first asset element in the historic object state storage 202 at an Nth time. In addition, for the data object 310, the element 320 is a first asset element in the current object state storage 200 at a current time, while the element 322 is a first asset element in the historic object state storage 202 at a (current−Xth) time, and the element 324 is a first asset element in the historic object state storage 202 at an Nth time. In addition, for the data object 312, the element 326 is a first asset element in the current object state storage 200 at a current time, while the element 328 is a first asset element in the historic object state storage 202 at a (current−Xth) time, and the element 330 is a first asset element in the historic object state storage 202 at an Nth time.

Referring back to FIG. 1, the object comparator system 36 compares the objects in the current object state storage 200 to the historic object state storage 202 to determine changes in a given application 18, 20. Once a change in objects is determined, the object comparator system 36 generates information about the changes to be output by the output system 38, to be provided to the administrator system 24 or the remediation system 26. Accordingly, the change tracer system 12 monitors changes in applications 18, 20 over time.

The change tracer system 12 can utilize known indexing mechanisms to store only unique objects in the object state storages 200, 202 overtime. For example, the indexing can be performed by adding a timestamp and a file name into an index file. Such indexing of stored objects ensures that a range of historical changes are recorded and stored while maintaining a low space utilization of the memory 30. Accordingly, the overall change tracer system 12 is light weight with regard to processing and storage requirements. In addition, the index optimizing system 42 can be used to optimize the indexing of the unique objects. Such optimized indexing enables the object comparator system 40 to reconcile differences between objects, to analyze changes reflected in the compared objects, and to produce change tracer reports quickly and efficiently.

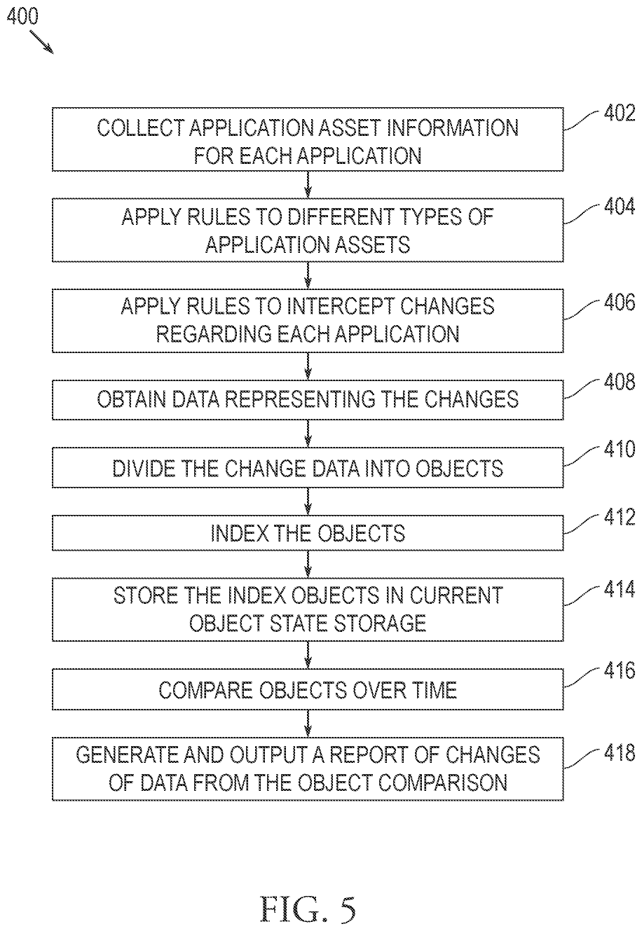

Referring to FIG. 5, a method 400 of operation of the system 10 includes the step 402 of collecting application asset information for each application 18, 20 using the instrument system 36. The method 400 then applies at least one predetermined rule in step 404 to different types of application assets 22, and applies at least one predetermined rule in step 406 to intercept changes regarding each application 18, 20 using a respective interceptor 44, 46 to generate change data. The method 400 then obtains the received change data and the collected application asset information representing the changes in a given application 18, 20 in step 408. The method 400 divides the change data into objects in step 410, and indexes the objects in step 412. The change storage 32 then stores the indexed objects in current object state storage 200 in step 414. The object comparator system 40 then compares the objects over time in step 416, and the output system 38 generates and outputs a report of the changes of data in step 418 resulting from the object comparison.

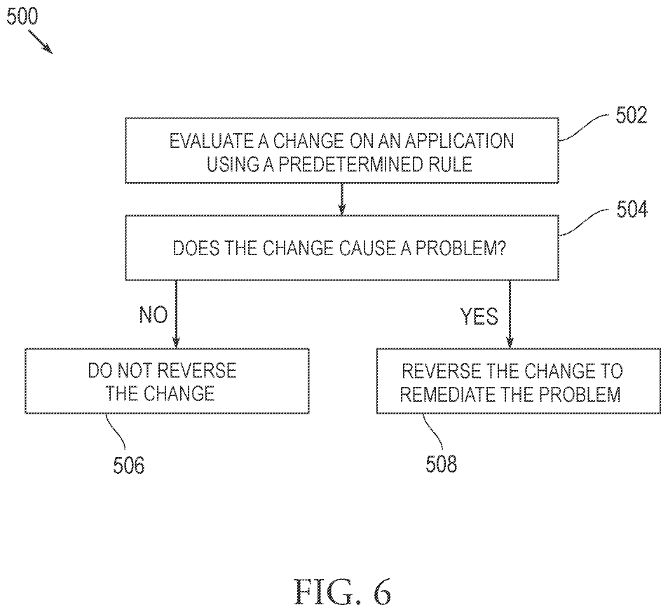

Referring to FIG. 6, a method 500 of operation of the remediation system 26 includes the steps of evaluating a change of an application using a predetermined rule in step 502, and checking in step 504 whether the change is determined to cause a problem. If a change is determined to cause a problem in step 504, the remediation system 26 does not reverse the change in step 506. However, if the change is determined to cause a problem in step 504, the remediation system 26 reverses the change in step 508 to remediate the problem.

Using the change tracer system 12, the system 10 can be implemented with diverse computer configurations, including mobile devices as at least one of the computing systems 14, 16. The system 10 can also be implemented in distributed computing environments in which tasks are performed by local or remote processing devices that are linked through a communication network, such as the Internet or an intranet of an organization. Such change tracing in a distributed computing can be utilized for surveillance and regulatory supervision. The system 10 can track and promulgate application updates through a network of applications. In addition, the system 10 automatically identifies the impact of a change in an application 18, 20, such as detecting services performed by the application 18, 20. For example, the system 10 can correlate artifacts of the changes from the collected data. Such artifacts can include changes in database schema, binaries, scripts, application schedulers, middleware, application servers, etc. Furthermore, the system 10 can trace changes in applications 18, 20 between deployment in a release cycle with artifacts which are in production.

Portions of the methods described herein can be performed by software or firmware in machine readable form on a tangible (e.g., non-transitory) storage medium. For example, the software or firmware can be in the form of a computer program including computer program code adapted to cause the system to perform various actions described herein when the program is run on a computer or suitable hardware device, and where the computer program can be embodied on a computer readable medium. Examples of tangible storage media include computer storage devices having computer-readable media such as disks, thumb drives, flash memory, and the like, and do not include propagated signals. Propagated signals can be present in a tangible storage media. The software can be suitable for execution on a parallel processor or a serial processor such that various actions described herein can be carried out in any suitable order, or simultaneously.

It is to be further understood that like or similar numerals in the drawings represent like or similar elements through the several figures, and that not all components or steps described and illustrated with reference to the figures are required for all embodiments or arrangements.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “contains”, “containing”, “includes”, “including,” “comprises”, and/or “comprising,” and variations thereof, when used in this specification, specify the presence of stated features, integers, steps, operations, elements, and/or components, but do not preclude the presence or addition of one or more other features, integers, steps, operations, elements, components, and/or groups thereof.

Terms of orientation are used herein merely for purposes of convention and referencing and are not to be construed as limiting. However, it is recognized these terms could be used with reference to an operator or user. Accordingly, no limitations are implied or to be inferred. In addition, the use of ordinal numbers (e.g., first, second, third) is for distinction and not counting. For example, the use of “third” does not imply there is a corresponding “first” or “second.” Also, the phraseology and terminology used herein is for the purpose of description and should not be regarded as limiting. The use of “including,” “comprising,” “having,” “containing,” “involving,” and variations thereof herein, is meant to encompass the items listed thereafter and equivalents thereof as well as additional items.

While the disclosure has described several exemplary embodiments, it will be understood by those skilled in the art that various changes can be made, and equivalents can be substituted for elements thereof, without departing from the spirit and scope of the invention. In addition, many modifications will be appreciated by those skilled in the art to adapt a particular instrument, situation, or material to embodiments of the disclosure without departing from the essential scope thereof. Therefore, it is intended that the invention not be limited to the particular embodiments disclosed, or to the best mode contemplated for carrying out this invention, but that the invention will include all embodiments falling within the scope of the appended claims.

The subject matter described above is provided by way of illustration only and should not be construed as limiting. Various modifications and changes can be made to the subject matter described herein without following the example embodiments and applications illustrated and described, and without departing from the true spirit and scope of the invention encompassed by the present disclosure, which is defined by the set of recitations in the following claims and by structures and functions or steps which are equivalent to these recitations.

1. A change tracer system configured to trace a change in an entire applied computer technology in a computing system, wherein the computing system is separate from the change tracer system, wherein the computer system includes the applied computer technology, wherein the computing system includes an interceptor system separate from the change tracer system and configured to monitor the entire applied computer technology, configured to intercept the change in the entire applied computer technology, and configured to generate current change data representing the change in the entire applied computer technology, comprising:
a harvest system separate from the computing system and separate from the interceptor system, and operatively connected to the interceptor system of the computing system and having a first processor including first code stored therein configured to receive, from the computing system, the current change data representing the change in the entire applied computer technology;
a change storage separate from the computing system and configured to store the received current change data, and to store historic change data associated with the applied computer technology;
a comparator system separate from the computing system and having a second processor including second code stored therein configured to compare the current change data with the historic change data, and to determine the change in the entire applied computer technology from the comparison of the current change data with the historic change data; and
an output system separate from the computing system and having a third processor including third code stored therein configured to output a report indicating the change in the entire applied computer technology.

2. The change tracer system of claim 1, wherein the interceptor system is installed in the applied computer technology selected from the group consisting of: hardware, software, and middleware.

3. The change tracer system of claim 1, further comprising:
a display having a user interface configured to display the outputted report.

4. The change tracer system of claim 1, wherein the report is in an email format.

5. The change tracer system of claim 1, further comprising:
a remediation system having a fourth processor including fourth code stored therein configured to remediate the change.

6. The change tracer system of claim 1, wherein the change storage is configured to store the current change data and the historic change data as change data objects, and
wherein the comparator system is configured to compare the change data objects corresponding to the current change data and the historic change data, and to determine the change in the entire applied computer technology from the comparison of change data objects.

7. The change tracer system of claim 6, further comprising:
an instrument system having a fourth processor with fourth code stored therein configured to receive application asset information associated with the applied computer technology from an external database,
wherein the change storage is configured to store the received application asset information as asset data objects, and
wherein the comparator system is configured to compare the asset data objects corresponding to the applied computer technology, and to determine the change in the entire applied computer technology from the comparison of change data objects and from the comparison of the asset data objects.

8. A system configured to trace a change in an entire applied computer technology, comprising:
a computing system including the applied computer technology and an interceptor system configured to monitor the entire applied computer technology, configured to intercept the change in the entire applied computer technology, and configured to generate current change data representing the change in the entire applied computer technology;
a harvest subsystem separate from the computing system and separate from the interceptor system, wherein the harvest subsystem is operatively connected to the interceptor system and having a first processor including first code stored therein configured to receive the current change data representing the change in the entire applied computer technology;
a change storage separate from the computing system and configured to store the received current change data, and to store historic change data associated with the applied computer technology;
a comparator subsystem separate from the computing system and having a second processor including second code stored therein configured to compare the current change data with the historic change data, and to determine the change in the entire applied computer technology from the comparison of the current change data with the historic change data;
an output subsystem separate from the computing system and having a third processor including third code stored therein configured to output a report indicating the change in the entire applied computer technology; and
a remediation subsystem separate from the computing system and having a fourth processor including fourth code stored therein configured to determine whether the change in the entire applied computer technology is proper, and in the case that the change in the entire applied computer technology is improper, to remediate the change.

9. The system of claim 8, wherein the applied computer technology is selected from the group consisting of: hardware, software, and middleware.

10. The system of claim 8, further comprising:
a display having a user interface configured to display the outputted report.

11. The system of claim 8, wherein the report is in an Email format.

12. The system of claim 8, wherein the change storage is configured to store the current change data and the historic change data as change data objects, and wherein the comparator subsystem is configured to compare the change data objects corresponding to the current change data and the historic change data, and to determine the change in the entire applied computer technology from the comparison of change data objects.

13. The system of claim 12, further comprising:
an instrument subsystem having a fifth processor with fifth code stored therein configured to receive application asset information associated with the applied computer technology from an external database,
wherein the change storage is configured to store the received application asset information as asset data objects, and
wherein the comparator subsystem is configured to compare the asset data objects corresponding to the applied computer technology, and to determine the change in the entire applied computer technology from the comparison of change data objects and from the comparison of the asset data objects.

14. A computer-based method, comprising:
providing a change tracer system including a harvest system;
providing a computing system separate from the change tracer system and separate from the harvest system, and including an applied computer technology and an interceptor system separate from the change tracer system and separate from the harvest system;
monitoring the entire applied computer technology using the interceptor system;
intercepting a change in the entire applied computer technology using the interceptor system;
generating change data representing the change in the entire applied computer technology using the interceptor system;
obtaining the change data representing the change in the entire applied computer technology at the harvest system of the change tracer system;
converting the change data into change data objects using the change tracer system;
comparing the change data objects over time using the change tracer system;
generating a report of the change in the entire applied computer technology from the comparison of change data objects using the change tracer system; and
outputting the report using the change tracer system.

15. The computer-based method of claim 14, wherein the applied computer technology is selected from the group consisting of: hardware, software, and
middleware.

16. The computer-based method of claim 14, wherein outputting the report includes:
displaying the report in a user interface of a display.

17. The computer-based method of claim 14, wherein generating the report includes generating the report in an Email format, and
wherein outputting the report includes Emailing the report.

18. The computer-based method of claim 14, further comprising:
determining whether the change in the entire applied computer technology is improper; and
in the case that the change in the entire applied computer technology is improper,
remediating the change.

19. The computer-based method of claim 14, further comprising:
storing the obtained change data as current change data objects and historic change data objects.

20. The computer-based method of claim 19, wherein the comparing of the change data objects over time further comprises:
comparing the current change data objects with the historic change data objects; and
determining the change in the entire applied computer technology from the comparison of the current change data objects and the historic change data objects.
